(19) United States
(12) Patent Application Publication
(10) Pub. No.: US 2023/0393282 A1
(43) Pub. Date: Dec. 7, 2023

(54) METHOD AND APPARATUS TO FACILITATE POSITIONAL CORRECTIONS FOR ATMOSPHERIC DELAY AND/OR ADVANCE

(71) Applicant: HERE Global B.V., Eindhoven (NL)

(72) Inventors: Saara KUISMANEN, Tampere (FI); Sakari Rautalin, Tampere (FI); Pekka-Henrik Niemenlehto, Nokia (FI); Tony Hoijer, Tampere (FI)

(73) Assignee: HERE Global B.V., Eindhoven (NL)

(21) Appl. No.: 17/834,231

(22) Filed: Jun. 7, 2022

(51) Int. Cl. G01S 19/07; G01S 19/24; G01S 19/40; G01S 19/05

(52) U.S. Cl. CPC G01S 19/07; G01S 19/243; G01S 19/40; G01S 19/05

(57) ABSTRACT

A method, apparatus and computer program product facilitate corrections to be made to a location determined utilizing a satellite-based positioning technique to reduce the errors introduced by atmospheric delay and/or advance of navigation signals propagating through an atmospheric layer, such as the ionosphere. In the context of a method for enabling a customized request for corrections to be made, the method includes determining a perimeter of a grid within which the corrections are sought and transmitting, toward a service provider, a request that identifies one or more correction points within the perimeter of the grid. In response to the request, the method includes receiving information associated with the corrections. The method also includes determining a position based upon the satellite-based positioning technique in combination with the received information associated with the corrections.

### TECHNOLOGICAL FIELD

An example embodiment relates generally to the determination of the position of a navigation device utilizing a satellite-based positioning technique and, more particularly, to the facilitation of corrections to the position of the navigation device to compensate for at least some atmospheric delay and/or advance of the navigation signals transmitted to the navigation device and utilized by the satellite-based positioning technique.

### BACKGROUND

Positioning and navigation solutions commonly depend upon a Global Navigation Satellite System (GNSS) with signals transmitted by GNSS satellites being received by GNSS receivers embedded in or otherwise carried by a variety of different devices. For example, smartphones, smart watches, vehicles, drones and other location-aware devices include GNSS receivers in order to allow the position of the device to be determined. In some instances, the device may include a navigation system and/or a navigation application that is dependent upon the signals received by the GNSS receiver in order to determine the position of the device and to provide navigational assistance. The number of devices that include GNSS receivers is growing rapidly with more types of devices including devices, such as Internet of Things (IOT) devices, with limited amounts of computational resources including GNSS receivers.

The GNSS family includes several satellite constellations including the Global Positioning System (GPS) and the Globalnaya Navigatsionnaya Sputnikovaya Sistema (GLONASS). Other GNSS satellite constellations include the Beidou system and the Galileo system. In addition to these global satellite constellations, several regional Satellite-Based Augmentation Systems (SBAS), such as the Quasi-Zenith Satellite System (QZSS), Multifunctional Transport Satellites (MTSAT) Satellite Augmentation System (MSAS), Wide Area Augmentation System (WAAS), European Geostationary Navigation Overlay Service (EGNOS), GPS-Aided Geostationary (GEO) Augmented Navigation (GAGAN), System for Differential Correction and Monitoring (SDCM) and the Indian Regional Navigation Satellite System (IRNSS) having an operational name of NavIC (Navigation with Indian Constellation), have been developed.

In a GNSS system, a navigation satellite orbiting the Earth transmits navigation signals including ranging codes and navigation data interleaved with the ranging codes that a GNSS receiver receives and utilizes to determine the position of the GNSS receiver and, in turn, the device in which the GNSS receiver is embedded. The ranging code allows the GNSS receiver to determine the time required for the signals to travel from the navigation satellite to the GNSS receiver, which correlates to the distance between the navigation satellite and the GNSS receiver. The navigation data includes a set of parameter values of an orbit model defining the orbit of the navigation satellite for a limited period of time. The parameter values provide navigation data known as ephemeris data. The ephemeris data may be utilized by the GNSS receiver to determine the position the navigation satellite relative to a predefined coordinate system at particular instances of time. Based on the positions of a plurality of navigation satellites, the clock information of the navigation satellites, such as the clock offsets of the navigation satellites relative to GNSS time, and the time required for the signals broadcast by the navigation satellites to be received by the GNSS receiver, the GNSS receiver is configured to determine its position.

The time required for the navigation signals broadcast by the navigation satellites to be received by the GNSS receiver is impacted by several different types of errors that, in turn, will result in an error in the position that is determined for the GNSS receiver. Some receivers, such as low-cost receivers, correct for only a small number of the errors such that the resulting position that is determined has only limited accuracy, such as accuracy within a range of five to ten meters. Other receivers, such as more expensive geodetic receivers, correct for a greater percentage or all of the errors such that the positional accuracy may be to within one centimeter or less.

The errors that impact the navigation signals transmitted from the navigation satellites to a GNSS receiver include errors associated with the satellite clocks, errors associated with the determination of the orbit of the navigation satellite, errors attributable to delays or advances of the navigation signals while propagating through the ionospheric layer, errors associated with delays or advances of the navigation signals while propagating through the tropospheric layer, errors associated with GNSS receiver noise and multipath errors. Although these various sources of error may contribute different amounts to the overall error associated with the position of a GNSS receiver that is determined from the navigation signals, examples of the positional errors attributable to the various sources of error include an error range of +/−2 meters for errors associated with the satellite clocks, an error range for +/−2.5 meters for errors associated with the orbit of the navigation satellite, an error range of +/−5 meters for errors attributable to delays or advances for navigation signals propagating through the ionospheric layer, an error range +/−0.5 meters for delays or advances for navigation signals propagating through the tropospheric layer, an error range for +/−0.3 meters for receiver noise and an error range of +/−1 meters for multipath errors.

Techniques for improving the performance of GNSS-based positioning have been developed including differential GNSS (D-GNSS), real-time-kinematic technology (RTK), precise point positioning (PPP) and PPP-RTK, as well as techniques that combine other positioning sources to improve performance such as inertial sensor integration, and the analysis of Wi-Fi, Bluetooth or other wireless signals. With respect to PPP, for example, different types of corrections are computed on the basis of data collected by a network of reference stations. The correction data includes corrections for one or more of satellite orbits and clocks, code biases, phase biases, ionospheric errors and tropospheric errors. A correction service may then transmit the correction data to navigation devices via a network connection. The navigation devices, in turn, can use the correction data to mitigate the effects of different types of errors.

As noted above, the errors attributable to advances and/or delays of the navigation signals propagating through the ionospheric layer may be the largest source of error in relation to the determination of the position of the navigation device. The error created by the ionosphere is attributable to the interaction of atmospheric particles with the navigation signals propagating through the ionosphere. The propagation speed of the navigation signals within the ionosphere and, in turn, the time required for the navigation signals to propagate through the ionosphere depends on the electron density of the ionosphere. The ionosphere is a dispersive medium such that the effect of the ionosphere on the navigation signals, such as the delay or advance of the navigation signals that is caused by the ionosphere, depends upon both the properties of the navigation signals, such as the frequency of the navigation signals, that are propagating therethrough as well as the respective locations of the navigation satellites and the GNSS receiver. By way of example of the frequency dependency and with respect to the navigation signals utilized by a GNSS-based positioning technique, the code modulations on the carrier waves experience a delay during their propagation through the ionosphere such that the code modulations appear to take longer to reach the GNSS receiver. However, the carrier waves themselves experience an advance during their propagation through the ionosphere such that the carrier waves appear to take less time to reach the GNSS receiver.

Ionospheric delays and advances can be represented by total electron content (TEC) values. TEC values can be mapped to corresponding delays or advances of the navigation signals based on the frequencies of the navigation signals, which are known to the GNSS receiver. TEC values constitute both a vertical TEC (VTEC) and a slant TEC (STEC). The VTEC represents the ionospheric delays or advances in an instance in which the navigation signal is propagating directly downward toward the earth, that is, in the direction defined by the earth's gravitational force. The STEC represents the ionospheric delay or advance in an instance in which the navigation signals are propagating at a non-zero angle relative to the direction defined by the earth's gravitational force, such that the navigation signals are propagating at an angle through the ionospheric layer and are therefore within the ionospheric layer for a longer period of time so as to experience additional delay or advance.

An ionospheric model can be defined in various manners. For example, an ionospheric model may be defined as a Klobuchar model, a NeQuick model, an IONosphere Map Exchange (IONEX) Global Ionosphere Maps (GIM) model, or a Quasi-Zenith Satellite System (QZSS) model or the ionospheric model may be defined by spherical harmonic coefficients. Some models, such as a Klobuchar model, have mutual parameters that apply globally, such that the ionospheric delay or advance at any given location is calculated from the same set of model parameters. Other models, however, are regional with the ionospheric delay or advance calculated utilizing different regional models. For example, the QZSS ionospheric model utilizes a plurality of regional models. Ionospheric corrections may therefore be provided for different regions, which leads to a number of grids.

Ionospheric correction models can be based on the expected or predicted behavior of the ionosphere or based on substantially real-time estimations. For example, the Klobuchar model is empirical and is based on an assumption that the ionosphere behaves in a predefined manner. As a result, the Klobuchar model can be relied upon to remove about 50% of the errors attributable to propagation of the navigation signals through the ionosphere. Other models, such as the IONEX GIM model are calculated using observations from GNSS satellites at reference stations. These models assume that the delays or advances of the navigation signals that are attributable to the ionosphere can be estimated from multi-frequency observations at the reference stations. By continuously estimating the delays or advances of the navigation signals caused by the ionosphere for multiple visible navigation satellites at a plurality of reference stations, a model of the TEC in the atmosphere can be created. The TEC model can, in turn, be utilized to estimate the delays or advances of navigation signals at a given time and location. Multiple different global IONEX GIM models are available, such as a rapid solution that is provided with a maximum of 24 hour latency and a predicted solution from both one and two days prior.

The Long Term Evolution (LTE) positioning protocol (LPP) specification defines an ionospheric model similar to the QZSS model. In these ionospheric models, a grid is defined which is associated with an area of the earth's surface at which ionospheric correction data will be valid. In this regard, a grid is a collection of points that cover an area of the earth's surface. Each point, in turn, may be defined as a two-dimensional coordinate identifying a point on the earth's surface, such as in terms of latitude and longitude. For each visible satellite within the area, STEC values are defined with the STEC values represented as polynomials and residuals. The STEC value at any grid point can therefore be calculated based upon an evaluation of the polynomial and the residual at the respective grid point. Between the grid points, STEC values may be determined by interpolating between the STEC values at nearby grid points. As each grid is associated with only a certain area, multiple grids may be defined in order to cover larger portions of the earth or to cover the entire earth.

For the various ionospheric grid models, such as the LPP model and the QZSS model, that are utilized to determine the delays or advances of the navigation signals propagating through the ionosphere, the grid is generally predefined. The STEC values provided by a grid may remain the same over time or may be updated from time to time. At any point in time, however, the grid utilized by an ionospheric model has a static configuration with all of the navigation devices utilizing the same grid.

The corrections associated with navigation signals propagating through the ionospheric layer are provided to a navigation device in various manners depending on the ionospheric model. For example, corrections in the LPP format may be delivered to the navigation device in three different messages. A first message, such as a GNSS-SSR-CorrectionPoints message, provides the grid definition. The other two message types provide the polynomial, such as via a GNSS-SSR-STEC-Correction message, and the residuals, such as a GNSS-SSR-Gridded Correction message, for each navigation satellite. The navigation device may only need to receive the first message once, or at least a fewer number of times than the other two messages. In contrast, the messages that provide the polynomial and residuals for each navigation satellite are updated on a more frequent basis to reflect changes in the delays and advances of the navigation signals that are attributable to the ionosphere, as well as changes in the positions of the navigation satellites. The frequency with which the messages relating to the polynomial and the residuals are updated may vary, depending upon the rate of change of the delays or advances of the navigation signals that are attributable to the ionosphere and the rate of change in the position of the navigation satellites.

In this example, a navigation device can request information regarding corrections to compensate for delays or advances of the navigation signals attributable to the ionosphere from a service provider utilizing a dedicated message type. For example, different message types may be utilized to request the grid definition as well as the polynomial and residuals for each navigation satellite. In one example embodiment, a GNSS-SSR-CorrectionPointsReq message, a GNSS-SSR-STEC-CorrectionReq message and a GNSS-SSR-GriddedCorrectionReq message may be utilized to request the grid definition, the polynomial and the residuals, respectively. With respect to the message requesting the grid definition, such as the grid layout, from the service provider, the GNSS-SSR-CorrectionPointsReq message is currently defined by the LPP specification to include a single parameter that identifies the grid. As such, a navigation device that is seeking updated ionospheric correction information utilizing a gridded correction model must know in advance information regarding the available grids and the identification of the grid(s) that are relevant to the navigation device. Moreover, the grid layouts that are available for use with ionospheric correction models are generally static and inflexible. While a grid layout may be suitable for certain navigation devices, other navigation devices may find that the grid layout fails to satisfy the requirements of these other navigation devices, such as in terms of data payload amount, transmission rates, accuracy requirements, spatial coverage of the grid and/or density of the grid. As such, in these instances, the grid layout of the ionospheric correction model may fail to provide sufficient error correction for errors attributable to advances or delays of the navigation signals propagating through the ionosphere since the configuration of the grid layout is at least partially incompatible or otherwise fails to satisfy the requirements of the navigation device.

### BRIEF SUMMARY

A method, apparatus and computer program product are provided in accordance with an example embodiment in order to facilitate the corrections to be made to a position determined utilizing a satellite-based positioning technique to reduce the errors introduced by atmospheric delay and/or advance of navigation signals propagating through an atmospheric layer, such as the ionosphere. In an example embodiment, a method, apparatus and computer program product are provided to facilitate customized requests for corrections to be made, thereby allowing the corrections for atmospheric delay and/or advance to be tailored for a requesting device, such as a navigation device and, as a result, to be more efficient for the requesting device and more compatible with the requirements of the requesting device. In another example embodiment, a method, apparatus and computer program product are provided for facilitating requests for corrections to be made that are based upon one or more location parameters associated with a position, such as a position of a navigation device, to ensure that the corrections are associated with a region that is of interest. As such, the method, apparatus and computer program product of the various example embodiments provide for enhanced corrections of errors attributable to atmospheric delay and/or advance and correspondingly more accurate determination of a position, such as the position of a navigation device.

In an example embodiment, a method is provided for enabling a customized request for corrections to be made by a requesting device. The corrections are for at least some atmospheric delay and/or advance incurred in conjunction with a satellite-based positioning technique. The method includes determining a perimeter of a grid within which the corrections are sought and transmitting, toward a service provider, a request that identifies one or more correction points within the perimeter of the grid. In response to the request, the method includes receiving information associated with the corrections. The method also includes determining a position based upon the satellite-based positioning technique in combination with the received information associated with the corrections.

The method of an example embodiment also includes defining an array of the one or more correction points based upon a reference point, a number of correction points or steps in each of one or more directions and a step size between adjacent correction points so as to populate the grid for which the information associated with the corrections is sought. In an example embodiment, the method further includes defining a list of the one or more correction points so as to populate the grid for which the information associated with the corrections is sought. The list may be defined, for example, based upon a reference point and a difference between adjacent correction points or by identifying a plurality of individual correction points that comprise the list. In an example embodiment, the method further includes defining the one or more correction points such that the one or more correction points for which information is receive have a predefined density. The method of an example embodiment also includes configuring the request to also identify an update rate at which the information associated with the corrections is to be updated by the service provider.

In another example embodiment, an apparatus is provided that is configured to enable a customized request for corrections to be made by a requesting device. The corrections are for at least some atmospheric delay and/or advance incurred in conjunction with a satellite-based positioning technique. The apparatus includes processing circuitry and at least one memory including computer program code with the at least one memory and the computer program code configured to, with the processing circuitry, cause the apparatus at least to determine a perimeter of a grid within which the corrections are sought and to transmit, toward a service provider, a request that identifies one or more correction points within the perimeter of the grid. The at least one memory and the computer program code are also configured to, with the processing circuitry, cause the apparatus to receive, in response to the request, information associated with the corrections. The at least one memory and the computer program code are further configured to, with the processing circuitry, cause the apparatus to determine a position based upon the satellite-based positioning technique in combination with the received information associated with the corrections.

The at least one memory and the computer program code are further configured to, with the processing circuitry, cause the apparatus of an example embodiment to define an array of the one or more correction points based upon a reference point, a number of correction points or steps in each of one or more directions and a step size between adjacent correction points so as to populate the grid for which the information associated with the corrections is sought. In an example embodiment, the at least one memory and the computer program code are further configured to, with the processing circuitry, cause the apparatus to define a list of the one or more correction points so as to populate the grid for which the information associated with the corrections is sought. The list may be defined, for example, based upon a reference point and a difference between adjacent correction points or by identifying a plurality of individual correction points that comprise the list. In an example embodiment, the at least one memory and the computer program code are further configured to, with the processing circuitry, cause the apparatus to define the one or more correction points such that the one or more correction points for which the information is received have a predefined density. The at least one memory and the computer program code are also configured to, with the processing circuitry, cause the apparatus of an example embodiment to configure the request to also identify an update rate at which the information associated with the corrections is to be updated by the service provider.

In a further example embodiment, a computer program product is configured to enable a customized request for corrections to be made by a requesting device. The corrections are for at least some atmospheric delay and/or advance incurred in conjunction with a satellite-based positioning technique. The computer program product includes at least one non-transitory computer-readable storage medium having computer-executable program code instructions stored therein with the computer-executable program code instructions including program code instructions to determine a perimeter of a grid within which the corrections are sought and program code instructions to transmit, toward a service provider, a request that identifies one or more correction points within the perimeter of the grid. In response to the request, the computer-executable program code instructions include program code instructions to receive information associated with the corrections. The computer-executable program code instructions also include program code instructions to determine a position based upon the satellite-based positioning technique in combination with the received information associated with the corrections.

The computer-executable program code instructions of an example embodiment also include program code instructions to define an array of the one or more correction points based upon a reference point, a number of correction points or steps in each of one or more directions and a step size between adjacent correction points so as to populate the grid for which the information associated with the corrections is sought. In an example embodiment, the computer-executable program code instructions further include program code instructions to define a list of the one or more correction points so as to populate the grid for which the information associated with the corrections is sought. The list may be defined, for example, based upon a reference point and a difference between adjacent correction points or by identifying a plurality of individual correction points that comprise the list. In an example embodiment, the computer-executable program code instructions also include program code instructions to define the one or more correction points such that the one or more correction points for which the information is received have a predefined density. The computer-executable program code instructions of an example embodiment also include program code instructions to configure the request to also identify an update rate at which the information associated with the corrections is to be updated by the service provider.

In yet another example embodiment, an apparatus is provided for enabling a customized request for corrections to be made by a requesting device. The corrections are for at least some atmospheric delay and/or advance incurred in conjunction with a satellite-based positioning technique. The apparatus includes means for determining a perimeter of a grid within which the corrections are sought and means for transmitting, toward a service provider, a request that identifies one or more correction points within the perimeter of the grid. In response to the request, the apparatus includes means for receiving information associated with the corrections. The apparatus also includes means for determining a position based upon the satellite-based positioning technique in combination with the received information associated with the corrections.

The apparatus of an example embodiment also includes means for defining an array of the one or more correction points based upon a reference point, a number of correction points or steps in each of one or more directions and a step size between adjacent correction points so as to populate the grid for which the information associated with the corrections is sought. In an example embodiment, the apparatus further includes means for defining a list of the one or more correction points so as to populate the grid for which the information associated with the corrections is sought. The list may identify the individual correction point(s). Alternatively, the list may be defined, for example, based upon a reference point and a difference between adjacent correction points or by identifying a plurality of correction points that comprise the list. In an example embodiment, the apparatus further includes means for defining the one or more correction points such that the one or more correction points have a predefined density. The apparatus of an example embodiment also includes means for configuring the request to also identify an update rate at which the information associated with the corrections is to be updated by the service provider.

In an example embodiment, a method is provided for responding to a customized request for corrections from a requesting device. The corrections are for at least some atmospheric delay and/or advance incurred in conjunction with a satellite-based positioning technique. The method includes receiving a request that identifies one or more correction points for which corrections are sought. In response to the request, the method includes identifying information associated with the corrections at the one or more correction points. The method further includes transmitting, toward the requesting device, the information associated with the corrections at the one or more correction points.

The method of an example embodiment receives the request by receiving the request that defines an array of the one or more correction points based upon a reference point, a number of correction points or steps in each of one or more directions and a step size between adjacent correction points. In this example embodiment, the method identifies the information by identifying the information associated with the corrections at the array of the one or more correction points. In another example embodiment, the method receives the request by receiving the request that defines a list of the one or more correction points. The list may individually identify the correction points or may be based upon a reference point and a difference between adjacent correction points. The method of this example embodiment identifies the information by identifying the information associated with the corrections at the list of the one or more correction points. In an example embodiment, the method receives the request by receiving the request that also identifies an update rate at which the information associated with the corrections at the one or more correction points is to be updated. The method of this example embodiment also includes repeatedly identifying the information associated with the corrections and repeatedly transmitting the information associated with the corrections in accordance with the update rate.

In another example embodiment, an apparatus is provided that is configured to respond to a customized request for corrections from a requesting device. The corrections are for at least some atmospheric delay and/or advance incurred in conjunction with a satellite-based positioning technique. The apparatus includes processing circuitry and at least one memory including computer program code with the at least one memory and the computer program code configured to, with the processing circuitry, cause the apparatus at least to receive a request that identifies one or more correction points for which corrections are sought. The at least one memory and the computer program code are also configured to, with the processing circuitry, cause the apparatus to identify, in response to the request, information associated with the corrections at the one or more correction points. The at least one memory and the computer program code are further configured to, with the processing circuitry, cause the apparatus to transmit, toward the requesting device, the information associated with the corrections at the one or more correction points.

The at least one memory and the computer program code are configured to, with the processing circuitry, cause the apparatus of an example embodiment to receive the request by receiving the request that defines an array of the one or more correction points based upon a reference point, a number of correction points or steps in each of one or more directions and a step size between adjacent correction points. In this example embodiment, the at least one memory and the computer program code are configured to, with the processing circuitry, cause the apparatus to identify the information by identifying the information associated with the corrections at the array of the one or more correction points. The at least one memory and the computer program code are configured to, with the processing circuitry, cause the apparatus of another example embodiment to receive the request by receiving the request that defines a list of the one or more correction points. The list may individually identify the correction points or may be based upon a reference point and a difference between adjacent correction points. In this example embodiment, the at least one memory and the computer program code are configured to, with the processing circuitry, cause the apparatus to identify the information by identifying the information associated with the corrections at the list of the one or more correction points. The at least one memory and the computer program code are configured to, with the processing circuitry, cause the apparatus of an example embodiment to receive the request by receiving the request that also identifies an update rate at which the information associated with the corrections at the one or more correction points is to be updated. In this example embodiment, the at least one memory and the computer program code are configured to, with the processing circuitry, cause the apparatus to repeatedly identify the information associated with the corrections and to repeatedly transmit the information associated with the corrections in accordance with the update rate.

In a further example embodiment, a computer program product is provided that is configured to respond to a customized request for corrections from a requesting device. The corrections are for at least some atmospheric delay and/or advance incurred in conjunction with a satellite-based positioning technique. The computer program product includes at least one non-transitory computer-readable storage medium having computer-executable program code instructions stored therein with the computer-executable program code instructions including program code instructions to receive a request that identifies one or more correction points for which corrections are sought. In response to the request, the computer-executable program code instructions include program code instructions to identify information associated with the corrections at the one or more correction points. The computer-executable program code instructions further include program code instructions to transmit, toward the requesting device, the information associated with the corrections at the one or more correction points.

In an example embodiment, the program code instructions to receive the request include program code instructions to receive the request that defines an array of the one or more correction points based upon a reference point, a number of correction points or steps in each of one or more directions and a step size between adjacent correction points. In this example embodiment, the program code instructions to identify the information include program code instructions to identify the information associated with the corrections at the array of the one or more correction points. In another example embodiment, the program code instructions to receive the request include program code instructions to receive the request that defines a list of the one or more correction points. The list may individually identify the correction points or may be based upon a reference point and a difference between adjacent correction points. In this example embodiment, the program code instructions to identify the information include program code instructions to identify the information associated with the corrections at the list of the one or more correction points. In an example embodiment, the program code instructions to receive the request include program code instructions to receive the request that also identifies an update rate at which the information associated with the corrections at the one or more correction points is to be updated. The computer-executable program code instructions of this example embodiment also include program code instructions to repeatedly identify the information associated with the corrections and program code instructions to repeatedly transmit the information associated with the corrections in accordance with the update rate.

In yet another example embodiment, an apparatus is provided for responding to a customized request for corrections from a requesting device. The corrections are for at least some atmospheric delay and/or advance incurred in conjunction with a satellite-based positioning technique. The apparatus includes means for receiving a request that identifies one or more correction points for which corrections are sought. In response to the request, the apparatus includes means for identifying information associated with the corrections at the one or more correction points. The apparatus further includes means for transmitting, toward the requesting device, the information associated with the corrections at the one or more correction points.

In an example embodiment, the means for receiving the request includes means for receiving the request that defines an array of the one or more correction points based upon a reference point, a number of correction points or steps in each of one or more directions and a step size between adjacent correction points. In this example embodiment, the means for identifying the information includes means for identifying the information associated with the corrections at the array of the one or more correction points. In another example embodiment, the means for receiving the request includes means for receiving the request that defines a list of the one or more correction points. The list may individually identify the correction points or may be based upon a reference point and a difference between adjacent correction points. In this example embodiment, the means for identifying the information includes means for identifying the information associated with the corrections at the list of the one or more correction points. In an example embodiment, the means for receiving the request includes means for receiving the request that also identifies an update rate at which the information associated with the corrections at the one or more correction points is to be updated. The apparatus of this example embodiment also includes means for repeatedly identifying the information associated with the corrections and means for repeatedly transmitting the information associated with the corrections in accordance with the update rate.

In an example embodiment, a method is provided for enabling a request for corrections to be made by a requesting device. The corrections are for at least some atmospheric delay and/or advance incurred in conjunction with a satellite-based positioning technique. The method includes transmitting, toward a service provider, the request that provides one or more location parameters associated with a position at which the corrections are sought. The method also includes receiving information associated with the corrections at the position of the navigation device as defined by the one or more location parameters. The method further includes determining an updated position based upon the information associated with the corrections at the position defined by the one or more location parameters.

The method of an example embodiment receives information by receiving the information associated with the corrections at correction points of a grid. In an example embodiment, the method receives information by receiving the information associated with the corrections at correction points of a plurality of grids identified based upon the position as defined by the one or more location parameters. The method of an example embodiment also includes configuring the request to identify an update rate at which the information associated with the corrections at the position, as defined by the one or more location parameters, is to be updated by the service provider. In an example embodiment, the method additionally includes configuring the request to identify a perimeter of a grid including at least the position, as defined by the one or more location parameters, within which the information associated with the corrections is sought. The method of an example embodiment may also include configuring the request to identify a density of correction points of a grid including at least the position, as defined by the one or more location parameters, within which the information associated with the corrections is sought.

In another example embodiment, an apparatus is provided that is configured to enable a request for corrections to be made by a requesting device. The corrections are for at least some atmospheric delay and/or advance incurred in conjunction with a satellite-based positioning technique. The apparatus includes processing circuitry and at least one memory including computer program code with the at least one memory and the computer program code configured to, with the processing circuitry, cause the apparatus at least to transmit, toward a service provider, the request that provides one or more location parameters associated with a position at which the corrections are sought. The at least one memory and the computer program code are also configured to, with the processing circuitry, cause the apparatus to receive information associated with the corrections at the position of the navigation device as defined by the one or more location parameters. The at least one memory and the computer program code are further configured to, with the processing circuitry, cause the apparatus to determine an updated position based upon the satellite-based positioning technique in combination with the information associated with the corrections at the position defined by the one or more location parameters.

The at least one memory and the computer program code are configured to, with the processing circuitry, cause the apparatus of an example embodiment to receive information by receiving the information associated with the corrections at correction points of a grid. In an example embodiment, the at least one memory and the computer program code are configured to, with the processing circuitry, cause the apparatus to receive information by receiving the information associated with the corrections at correction points of a plurality of grids identified based upon the position as defined by the one or more location parameters. The at least one memory and the computer program code are further configured to, with the processing circuitry, cause the apparatus to configure the request to identify an update rate at which the information associated with the corrections at the position, as defined by the one or more location parameters, is to be updated by the service provider. In an example embodiment, the at least one memory and the computer program code are further configured to, with the processing circuitry, cause the apparatus to configure the request to identify a perimeter of a grid including at least the position, as defined by the one or more location parameters, within which the information associated with the corrections is sought. The at least one memory and the computer program code may also be configured to, with the processing circuitry, cause the apparatus of an example embodiment to configure the request to identify a density of correction points of a grid including at least the position, as defined by the one or more location parameters, within which the information associated with the corrections is sought.

In a further example embodiment, a computer program product is provided that is configured to enable a request for corrections to be made by a requesting device. The corrections are for at least some atmospheric delay and/or advance incurred in conjunction with a satellite-based positioning technique. The computer program product includes at least one non-transitory computer-readable storage medium having computer-executable program code instructions stored therein with the computer-executable program code instructions including program code instructions to transmit, toward a service provider, the request that provides one or more location parameters associated with a position at which the corrections are sought. The computer-executable program code instructions also include program code instructions to receive information associated with the corrections at the position of the navigation device as defined by the one or more location parameters. The computer-executable program code instructions further include program code instructions to determine an updated position based upon the satellite-based positioning technique in combination with the information associated with the corrections at the position defined by the one or more location parameters.

The program code instructions of an example embodiment to receive information include program code instructions to receive the information associated with the corrections at correction points of a grid. In an example embodiment, the program code instructions to receive information include program code instructions to receive the information associated with the corrections at correction points of a plurality of grids identified based upon the position as defined by the one or more location parameters. The computer-executable program code instructions of an example embodiment also include program code instructions to configure the request to identify an update rate at which the information associated with the corrections at the position, as defined by the one or more location parameters, is to be updated by the service provider. In an example embodiment, the computer-executable program code instructions additionally include program code instructions to configure the request to identify a perimeter of a grid including at least the position, as defined by the one or more location parameters, within which the information associated with the corrections is sought. The computer-executable program code instructions of an example embodiment may also include program code instructions to configure the request to identify a density of correction points of a grid including at least the position, as defined by the one or more location parameters, within which the information associated with the corrections is sought.

In yet another example embodiment, an apparatus is provided for enabling a request for corrections to be made by a requesting device. The corrections are for at least some atmospheric delay and/or advance incurred in conjunction with a satellite-based positioning technique. The apparatus includes means for transmitting, toward a service provider, the request that provides one or more location parameters associated with a position at which the corrections are sought. The apparatus also includes means for receiving information associated with the corrections at the position of the navigation device as defined by the one or more location parameters. The apparatus further includes means for determining an updated position based upon the satellite-based positioning technique in combination with the information associated with the corrections at the position defined by the one or more location parameters.

The means for receiving information includes, in one example embodiment, means for receiving the information associated with the corrections at correction points of a grid. In an example embodiment, the means for receiving information includes means for receiving the information associated with the corrections at correction points of a plurality of grids identified based upon the position as defined by the one or more location parameters. The apparatus of an example embodiment also includes means for configuring the request to identify an update rate at which the information associated with the corrections at the position, as defined by the one or more location parameters, is to be updated by the service provider. In an example embodiment, the apparatus additionally includes means for configuring the request to identify a perimeter of a grid including at least the position, as defined by the one or more location parameters, within which the information associated with the corrections is sought. The apparatus of an example embodiment may also include means for configuring the request to identify a density of correction points of a grid including at least the position, as defined by the one or more location parameters, within which the information associated with the corrections is sought.

In an example embodiment, a method is provided for responding to a request for corrections for at least some atmospheric delay and/or advance incurred in conjunction with a satellite-based positioning technique. The method includes receiving a request that provides one or more location parameters associated with a position at which the corrections are sought. In response to the request, the method identifies information associated with the corrections at the position as defined by the one or more location parameters. The method further includes transmitting the information associated with the corrections at the position as defined by the one or more location parameters.

The method of an example embodiment identifies the information associated with the corrections by identifying the information associated with the corrections at correction points of a grid. In an example embodiment, the method identifies the information associated with the corrections by identifying the information associated with the corrections at correction points of a plurality of grids identified based upon the position as defined by the one or more location parameters. The method of an example embodiment receives the request by receiving the request that also identifies a perimeter of a grid including at least the position, as defined by the one or more location parameters, within which the information associated with the corrections is sought. The method of an example embodiment may also receive the request that identifies a density of correction points of a grid including at least the position, as defined by the one or more location parameters, within which the information associated with the corrections is sought.

The method of an example embodiment receives the request by receiving the request that also identifies an update rate at which the information associated with the corrections at the position, as defined by the one or more location parameters, is to be updated. In this example embodiment, the method repeatedly identifies the information associated with the corrections and repeatedly transmits the information associated with the corrections in accordance with the update rate.

In another example embodiment, an apparatus is provided that is configured to respond to a request for corrections for at least some atmospheric delay and/or advance incurred in conjunction with a satellite-based positioning technique. The apparatus includes processing circuitry and at least one memory including computer program code with the at least one memory and the computer program code configured to, with the processing circuitry, cause the apparatus at least to receive a request that provides one or more location parameters associated with a position at which the corrections are sought. In response to the request, the at least one memory and the computer program code are configured to, with the processing circuitry, cause the apparatus to identify information associated with the corrections at the position as defined by the one or more location parameters. The at least one memory and the computer program code are also configured to, with the processing circuitry, cause the apparatus to transmit the information associated with the corrections at the position as defined by the one or more location parameters.

The at least one memory and the computer program code are configured to, with the processing circuitry, cause the apparatus of an example embodiment to identify the information associated with the corrections by identifying the information associated with the corrections at correction points of a grid associated with a region that includes at least the position as defined by the one or more location parameters. In an example embodiment, the at least one memory and the computer program code are configured to, with the processing circuitry, cause the apparatus to identify the information associated with the corrections by identifying the information associated with the corrections at correction points of a plurality of grids identified based upon the position as defined by the one or more location parameters. The at least one memory and the computer program code are configured to, with the processing circuitry, cause the apparatus of an example embodiment to receive the request by receiving the request that also identifies a perimeter of a grid including at least the position, as defined by the one or more location parameters, within which the information associated with the corrections is sought. The at least one memory and the computer program code may also be configured to, with the processing circuitry, cause the apparatus of an example embodiment to receive the request that identifies a density of correction points of a grid including at least the position, as defined by the one or more location parameters, within which the information associated with the corrections is sought.

The at least one memory and the computer program code are configured to, with the processing circuitry, cause the apparatus of an example embodiment to receive the request by receiving the request that also identifies an update rate at which the information associated with the corrections at the position, as defined by the one or more location parameters, is to be updated. In this example embodiment, the at least one memory and the computer program code are also configured to, with the processing circuitry, cause the apparatus to repeatedly identify the information associated with the corrections and repeatedly transmit the information associated with the corrections in accordance with the update rate.

In a further example embodiment, a computer program product is provided that is configured to respond to a request for corrections for at least some atmospheric delay and/or advance incurred in conjunction with a satellite-based positioning technique. The computer program product includes at least one non-transitory computer-readable storage medium having computer-executable program code instructions stored therein with the computer-executable program code instructions including program code instructions to receive a request that provides one or more location parameters associated with a position device at which the corrections are sought. In response to the request, the computer-executable program code instructions also include program code instructions to identify information associated with the corrections at the position as defined by the one or more location parameters. The computer-executable program code instructions further include program code instructions to transmit the information associated with the corrections at the position as defined by the one or more location parameters.

The program code instructions to identify the information associated with the corrections include, in an example embodiment, program code instructions to identify the information associated with the corrections at correction points of a grid that includes at least the position as defined by the one or more location parameters. In an example embodiment, the program code instructions to identify the information associated with the corrections include program code instructions to identify the information associated with the corrections at correction points of a plurality of grids identified based upon the position as defined by the one or more location parameters. In an example embodiment, the program code instructions to receive the request include program code instructions to receive the request that also identifies a perimeter of a grid including at least the position, as defined by the one or more location parameters, within which the information associated with the corrections is sought. The program code instructions to receive the request may also include program code instructions to receive the request that identifies a density of correction points of a grid including at least the position, as defined by the one or more location parameters, within which the information associated with the corrections is sought.

The program code instructions to receive the request include, in an example embodiment, program code instructions to receive the request that also identifies an update rate at which the information associated with the corrections at the position, as defined by the one or more location parameters, is to be updated. In this example embodiment, the computer-executable program code instructions further include program code instructions to repeatedly identify the information associated with the corrections and program code instructions to repeatedly transmit the information associated with the corrections in accordance with the update rate.

In yet another example embodiment, an apparatus is provided that is configured to respond to a request for corrections for at least some atmospheric delay and/or advance incurred in conjunction with a satellite-based positioning technique. The apparatus includes means for receiving a request that provides one or more location parameters associated with a position at which the corrections are sought. In response to the request, the apparatus includes means for identifying information associated with the corrections at the position as defined by the one or more location parameters. The apparatus further includes means for transmitting the information associated with the corrections at the position as defined by the one or more location parameters.

The means for identifying the information associated with the corrections includes, in an example embodiment, means for identifying the information associated with the corrections at correction points of a grid that includes at least the position as defined by the one or more location parameters. In an example embodiment, the means for identifying the information associated with the corrections includes means for identifying the information associated with the corrections at correction points of a plurality of grids identified based upon the position as defined by the one or more location parameters. The means for receiving the request includes, in an example embodiment, means for receiving the request that also identifies a perimeter of a grid including at least the position, as defined by the one or more location parameters, within which the information associated with the corrections is sought. The means for receiving the request may also include means for receiving a request that identifies a density of correction points of a grid including at least the position, as defined by the one or more location parameters, within which the information associated with the corrections is sought.

The means for receiving the request includes, in an example embodiment, means for receiving the request that also identifies an update rate at which the information associated with the corrections at the position, as defined by the one or more location parameters, is to be updated. In this example embodiment, the apparatus includes means for repeatedly identifying the information associated with the corrections and means for repeatedly transmitting the information associated with the corrections in accordance with the update rate.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 is a system diagram illustrating the propagation of navigation signals from a navigation satellite to a navigation device, which is also in communication with a service provider;

FIG. 2 is a block diagram of an apparatus that may be specifically configured in accordance with an example embodiment of the present disclosure;

FIG. 3 is a flow chart of the operations performed, such as by the apparatus of FIG. 2 as embodied by a requesting device, in order to enable a customized request for corrections to be made in accordance with an example embodiment;

FIG. 4 is a block diagram of the operations performed, such as by the apparatus of FIG. 2 as embodied by the computing device of a service provider, in order to respond to a customized request for corrections in accordance with an example embodiment;

FIG. 5 is a block diagram of the operations performed, such as by the apparatus of FIG. 2 as embodied by a requesting device, in order to enable a request for corrections to be made that is based upon a position for which information regarding the corrections is sought in accordance with an example embodiment; and

FIG. 6 is a block diagram of the operations performed, such as by the apparatus of FIG. 2 as embodied by the computing device of a service provider, in order to respond to a request for corrections that is based at least in part upon a position for which information regarding the corrections is sought in accordance with an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

In the context of a satellite-based positioning technique, such as a GNSS-based positioning technique, a method, apparatus and computer program product are provided in accordance with an example embodiment in order to facilitate corrections to the position otherwise determined by the satellite-based positioning technique in order to compensate for at least some atmospheric delay and/or advance of the navigation signals propagating through the atmosphere. Although the method, apparatus and computer program product may be configured to correct for the delay and/or advance of navigation signals propagating through any of a variety of different atmospheric layers, the method, apparatus and computer program product of an example embodiment are configured to correct for the delay and/or advance of navigation signals propagating through the ionosphere. Additionally, while the method, apparatus and computer program product may be configured to provide for the correction of the position that is determined by any of a variety of satellite-based positioning techniques, the method, apparatus and computer program product of an example embodiment are configured to provide for the correction of the position determined by a GNSS-based positioning technique.

As described below, the method, apparatus and computer program product of an example embodiment are configured to provide for the correction for at least some of the atmospheric delay and/or advance experienced by navigation signals in a manner that is tailored for the requesting device, that is, the device requesting the correction, such as by defining the grid layout via which correction information is provided in a manner that is requested by the requesting device and/or by providing correction information based upon location parameter(s) associated with the position for which corrections are sought. Thus, the position that is determined by the satellite-based positioning technique may compensate for at least some atmospheric delay and/or advance so as to increase the accuracy with which the position is determined and may do so in a manner that is tailored for the requesting device and does not necessarily rely upon the same correction information that is provided to other requesting devices. Additionally, implementation of the ionospheric corrections may also advantageously effect the convergence time.

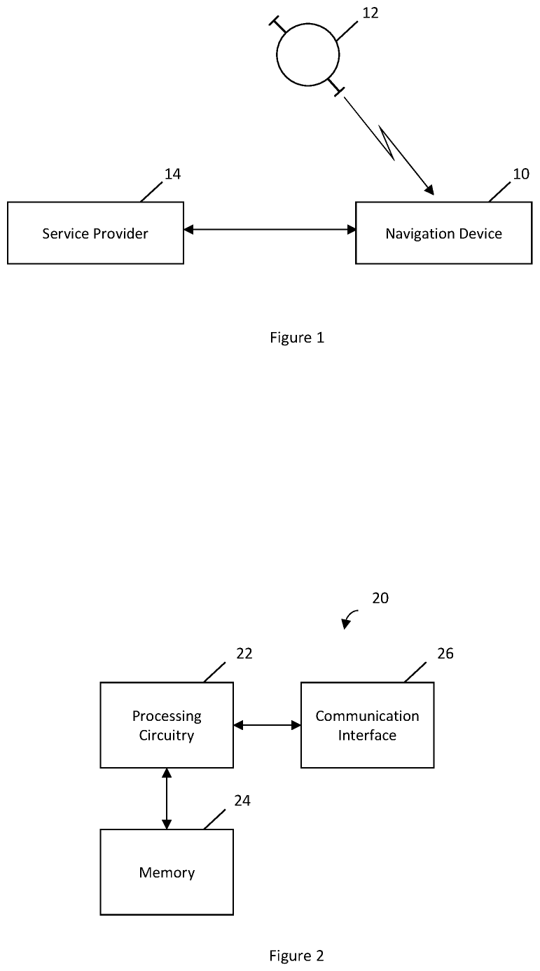

Referring now to FIG. 1, a system that is configured to determine a position, such as the position of a navigation device 10, utilizing a satellite-based positioning technique, such as a GNSS-based positioning technique, is depicted. In this regard, a navigation satellite 12 is depicted that broadcasts data including navigation data to one or more navigation devices. Although a single navigation satellite is depicted for purposes of illustration, the navigation satellite is typically one of a constellation of navigation satellites that orbit the earth. For example, the navigation satellite may be a GNSS satellite, such as a GPS satellite, a GLONASS satellite, a Beidou satellite, a Galileo satellite or a regional SBAS satellite. Regardless of the type of navigation satellite, the navigation satellite provides navigation signals, such as on a periodic basis, that include a ranging code and ephemeris data interleaved with the ranging code that defines the orbit of the navigation satellite during the lifetime of the ephemeris data, such as for a predefined period of time, e.g., 2 to 4 hours. Based upon the ephemeris data, the position of the navigation satellite may be determined within the predefined period of time.

The navigation device 10 that receives the data, including the navigation data, broadcast by the navigation satellite 12 may include a receiver, such as a GNSS receiver, for receiving the signals transmitted by the navigation satellite. The navigation device may be embodied by any of a variety of devices including, for example, a mobile device, such as mobile terminal, e.g., a personal digital assistant (PDA), mobile telephone, smart phone, personal navigation device, smart watch, tablet computer or any combination of the aforementioned and other types of portable computing devices, or a positioning or navigation system such as a positioning or navigation system onboard a vehicle, e.g., an automobile, a truck, a drone, a train, a satellite. Although only a single navigation device is depicted in FIG. 1 for purposes of illustration, a plurality of navigation devices may receive the navigation data from the navigation satellite in other embodiments.

Based at least in part upon the navigation data, the position of the navigation satellite 12, such as the orbit and/or the clock offset of the navigation satellite, may be predicted at one or more points in time within a prediction interval. The prediction interval may extend temporally beyond a predefined period of time during which the ephemeris data is valid so as to predict the position of the navigation satellite at each of a plurality of points in time following the lifetime of the ephemeris data. Although the position of the navigation satellite may be predicted at the plurality of points in time within the prediction interval in any of a variety of different manners, the position of the navigation satellite may be predicted utilizing a prediction algorithm, such as a prediction algorithm that provides an ephemeris extension of the ephemeris data.

In order to more accurately determine a position, such as the position of the navigation device 10, the system also includes a service provider 14. In the illustrated embodiment, the service provider is in communication with a requesting device and is configured to provide information to the requesting device regarding corrections to be made to compensate for a source of error within the navigation signals and/or the position that is determined. In this regard, the service provider of an example embodiment is configured to provide information to the requesting device regarding corrections to compensate for at least some atmospheric delay and/or advance of the navigation signals transmitted by a navigation satellite 12, such as during the propagation of the navigation signals through the ionosphere. Although depicted as a discrete element, the service provider of other example embodiments may be provided by a cloud-based computing system.

Although described herein by way of example, but not of limitation, with respect to communication between the service provider 14 and a navigation device 10 in order to improve the position otherwise determined for the navigation device utilizing a satellite-based positioning technique, the service provider may be in communication with and may provide information regarding corrections to be made to various other devices or systems, such as a data provider, a telecommunications provider or the like. As such, the requesting device may be a navigation device in some embodiments, but may be other devices or systems in other embodiments, such as a data provider, a telecommunications provider or the like. In an instance in which the requesting device is a data provider, a telecommunications provider or the like, the service provider may provide information regarding corrections to be made at various points within a region serviced by the data provider, the telecommunications provider or the like such that the data provider, the telecommunications provider or the like can, in turn, provide the information regarding the corrections to be made to downstream devices located within the region such that the downstream devices can compensate for at least some atmospheric delay and/or advance of the navigation signals transmitted by a navigation satellite 12. Additionally or alternatively, the data provider, the telecommunications provider or the like may take into account the information regarding the corrections to be made in relation to its communication with a downstream device. In some embodiments, the requesting device and/or the service provider may be a cloud-based computing device.

Referring now to FIG. 2, an apparatus 20 that may be configured to facilitate the correction of the position that has been determined, such as for a navigation device 10, so as to compensate for at least some atmospheric delay and/or advance of the navigation signals propagating through the atmosphere, such as the ionosphere, is depicted. The apparatus may be embodied by a requesting device, such as the navigation device, a data provider, a telecommunications provider or the like, or may be otherwise associated with the requesting device, such as in an embodiment in which the apparatus is embodied by a computing device in communication with the requesting device that is configured to determine a position, such as the position of the navigation device, or at least corrections to the position. In one embodiment in which the apparatus is embodied by or associated with the requesting device, the apparatus is configured to enable a customized request for corrections to be made, with the corrections being for at least some atmospheric delay and/or advance of the navigation signals relied upon by a satellite-based positioning technique to determine a position, such as the position of the navigation device. In another embodiment in which the apparatus is embodied by or associated with the requesting device, the apparatus is configured to enable a request for corrections to be made by the requesting device with the corrections being for at least some of the atmospheric delay and/or advance experienced by the navigation signals and with the request being at least partially based upon one or more location parameters associated with the position of interest, such as the position of the navigation device.

Alternatively, the apparatus 20 of other example embodiments may be embodied by a computing device, such as a server, of a service provider 14, such as a service provider configured to support satellite-based positioning techniques, such as GNSS-based positioning techniques. In one embodiment in which the apparatus is embodied by or associated with a computing device of the service provider, the apparatus configured to respond to a customized request for corrections from a requesting device, with the corrections being for at least some atmospheric delay and/or advance of the navigation signals relied upon to determine a position, such as the position of the navigation device, in accordance with by a satellite-based positioning technique. In another embodiment in which the apparatus is embodied by or associated with a computing device of the service provider, the apparatus is configured to respond to a request for corrections from a requesting device with the corrections being for at least some of the atmospheric delay and/or advance experienced by the navigation signals and with the request being at least partially based upon one or more location parameters associated with the position for which corrections are sought.

In conjunction with the embodiments in which the apparatus 20 is embodied by or associated with a requesting device as well as the embodiments in which the apparatus is embodied by or associated with a computing device of a service provider 14, the apparatus includes, is associated with or is in communication with processing circuitry 22, a memory device 24 and a communication interface 26, as shown in FIG. 2. In some embodiments, the processing circuitry (and/or co-processors or any other processors assisting or otherwise associated with the processing circuitry) can be in communication with the memory device via a bus for passing information among components of the apparatus. The memory device can be non-transitory and can include, for example, one or more volatile and/or non-volatile memories. In other words, for example, the memory device may be an electronic storage device (for example, a computer readable storage medium) comprising gates configured to store data (for example, bits) that can be retrievable by a machine (for example, a computing device like the processing circuitry). The memory device can be configured to store information, data, content, applications, instructions, or the like for enabling the apparatus to carry out various functions in accordance with an example embodiment of the present disclosure. For example, the memory device can be configured to buffer input data for processing by the processing circuitry. Additionally or alternatively, the memory device can be configured to store instructions for execution by the processing circuitry.

The processing circuitry 22 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 22 can be configured to execute instructions stored in the memory device 24 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 20 of an example embodiment can also include the communication interface 26. The communication interface can be any means such as a device or circuitry embodied in either hardware or a combination of hardware and software that is configured to receive and/or transmit data from/to other electronic devices in communication with the apparatus, such as by providing for communication with the service provider 14 and/or a navigation device 10 or other requesting device of the service provider. The communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication.

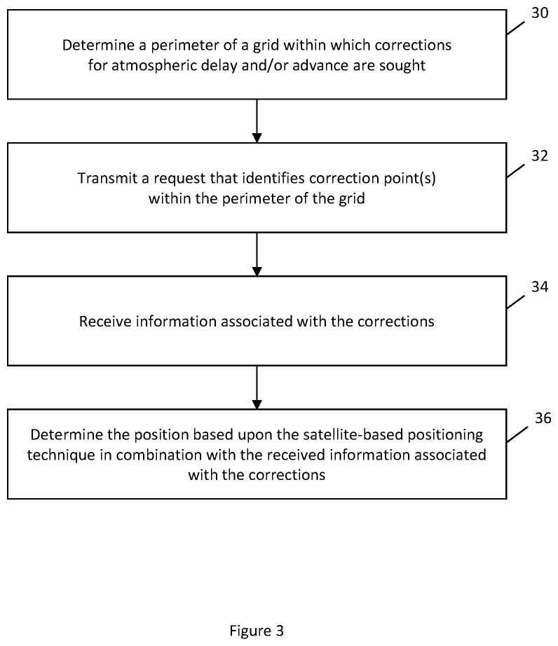

Referring now to FIG. 3, the operations performed, such as by the apparatus 20 of FIG. 2, in accordance with an example embodiment in which the apparatus is embodied by or associated with a requesting device, such as the navigation device 10, and is configured to enable a customized request for corrections to be made by the requesting device with the corrections compensating for at least some of the atmospheric delay and/or advance experienced by navigation signals propagating through the atmosphere, such as the ionosphere. In this example embodiment and as shown in block 30 of FIG. 3, the apparatus includes means, such as the processing circuitry 22 or the like, for determining for a perimeter of a grid that covers a corresponding geographic region within which the corrections are sought. As noted above, the correction is for at least some of the atmospheric delay and/or advance of the navigation signals propagating through the atmosphere, such as the ionosphere, and utilized by a satellite-based positioning technique, such as a GNSS-based positioning technique, to determine a position, such as the position of the navigation device or a position within a region serviced by a data provider, a telecommunications provider or the like.

The apparatus 20, such as the processing circuitry 22, is configured to determine the perimeter of the grid within which the corrections are sought. In one embodiment, the processing circuitry is configured to determine the perimeter of the grid within which corrections are sought based upon information regarding the current position of the navigation device 10. The current position of the navigation device, such as an approximate position of the navigation device, may be estimated in various manners and, as such, may be referred to as an estimated current position. For example, the information regarding the estimated current position of the navigation device may be the position of the navigation device that is determined by the satellite-based positioning technique, such as the GNSS-based positioning technique, without having corrected for the errors attributable to the atmosphere, such as the ionosphere. In this regard, the information regarding the position of the navigation device provides information that at least approximates the actual current position of the navigation device. However, the information regarding the estimated current position of the navigation device may be determined in another manner, such as based upon the position of the navigation device that was determined at a prior point in time along with information regarding movement of the navigation device from the prior point in time to the current point in time, such as provided by an inertial measurement unit. As yet another example, the information regarding the estimated current position of the navigation device may be based upon a comparison of radio signals received by the navigation device, such as Wi-Fi signals, Bluetooth signals or other wireless signals, to a radio map that identifies the anticipated strength of one or more types of radio signals at a variety of different locations.

The apparatus 20, such as the processing circuitry 22, is configured in one embodiment to determine the perimeter of the grid within which the corrections are sought to include not just the estimated current position of the navigation device 10, but an area around the estimated current position of the navigation device. In this regard, the area around the estimated current location of the navigation device that is included within the perimeter of the grid within which corrections are sought may be defined in such a manner that the actual position of the navigation device has a high likelihood of being within the perimeter of the grid. As such, the size of the area about the estimated current position of the navigation device may be predefined or may be defined based upon one or more parameters associated with the navigation device, such as the velocity with which the navigation device is moving. In this example embodiment, the area about the estimated current position of the navigation device may be sized in a manner proportional to the velocity such that a grid having a larger perimeter within which corrections are sought is identified in instances in which the navigation device is determined to be moving more quickly than in instances in which the navigation device is determined to be moving more slowly.

The apparatus 20, such as the processing circuitry 22, may be configured to determine the perimeter of the grid within which corrections are sought in other manners. In this regard, a request for the corrections may be made that includes an indication of the perimeter of the grid within which corrections are sought. In this regard, the perimeter of the grid within which corrections are sought may be defined to be the same as or a subset of a region serviced by a data provider, a telecommunications provider or the like. For example, a telecommunications provider may desire ionospheric corrections in a particular region, e.g., country, but be unable to determine the corrections itself. As such, the telecommunications provider of this example embodiment may be configured to request corrections and may provide a definition of for a perimeter of the grid within which the corrections are sought. As described below, the grid may alternatively be defined as an array or list of correction points.

Once the perimeter of the grid within which the corrections are sought has been determined, the apparatus 20 includes means, such as the processing circuitry 22, the communications interface 26 or the like, for transmitting a request that identifies one or more correction points within the perimeter of the grid within which the corrections are sought. See block 32 of FIG. 3. The request is transmitted toward the service provider 14, such as a service provider configured to provide corrections in support of a satellite-based positioning technique, such as a GNSS-based positioning technique. The one or more correction points within the perimeter of the grid within which corrections are sought may be defined in various manners, thereby permitting the requesting device, such as the navigation device 10, to define a custom grid layout. In addition, the apparatus of an example embodiment may include means, such as the processing circuitry or the like, for defining the one or more correction points within the perimeter of the grid within which the corrections are sought so as to have a predefined density. In one embodiment in which the correction points are evenly spaced throughout the grid, the predefined density serves to define the spacing between the correction points and the locations of the correction points within the grid. In some embodiments, the density may be separately defined in different directions, such as by defining a first density in a longitudinal direction and a second density in a latitudinal direction. Two examples are provided below by way of illustration, but not of limitation.

In one example embodiment, the apparatus 20 includes means, such as the processing circuitry 22 or the like, for defining an array of the one or more correction points based upon a reference point, the number of correction points or steps in each of one or more directions and a step size between adjacent correction points so as to populate a grid for which the information associated with the corrections is sought. In one example embodiment, the array is defined to identify the number of correction points or steps extending in two orthogonal directions from the reference point, such as in the longitudinal and latitudinal directions relative to the reference point. The step size between adjacent correction points may be the same in each direction or may differ between the different directions. In this example embodiment, the step size between adjacent correction points defines the resolution with which the information associated with the corrections is provided to the requesting device, such as the navigation device 10. In this regard, the resolution relates to the spacing between the correction points. In particular, defining a smaller step size results in information associated with corrections having a greater resolution than defining a larger step size between adjacent correction points. Based upon the definition of the reference point, the number of correction points or steps in each of one or more directions and the step size between the adjacent correction points, the grid including the correction points at which the information associated with the corrections is sought may be defined.

In another example embodiment, the apparatus 20 includes means, such as the processing circuitry 22 or the like, for defining a list of one or more correction points within the region for which the corrections are sought. The list may define the correction points in various manners. For example, the list may individually identify the correction points, which may be ordered or unordered. Alternatively, the one or more correction points in the list may be based upon a reference point and a difference, such as a positional difference, between adjacent correction points so as to populate a grid for which information associated with the corrections is sought. In this example embodiment, the difference between adjacent correction points defines the resolution with which the information associated with the corrections is provided to the requesting device, such as the navigation device 10. In particular, defining a smaller difference results in information associated with corrections having a greater resolution than defining a larger difference between adjacent correction points. Based upon the definition of the reference point and the difference between adjacent correction points, a grid having correction points at which the information associated with the corrections is sought may be defined to cover a corresponding geographical region. In some embodiments, the number of corrections points in the list may also be provided, either explicitly or implicitly.

The grid(s) of correction points that are discussed herein may be utilized in conjunction with any of a variety of different models configured to reduce the positional errors attributable to the delay and/or advance of navigation signals during propagation through an atmospheric layer, such as the ionosphere. By way of example, but not of limitation, the grid(s) may be compatible with the LPP specification, the QZSS atmosphere model and/or the SPARTN (Secure Position Augmentation for Real Time Navigation) atmosphere model, but may be tailored based upon the request from the requesting device, such as the navigation device 10.

As used herein, the perimeter of a grid defines a shape in which a collection of correction points is located. The perimeter of the grid within which the corrections are sought may have a regular or symmetrical shape about a reference point, such as about the estimated current position of the navigation device 10. For example, the perimeter of the grid may have a circular shape or a rectangular shape. The perimeter of a grid having these shapes may be defined by various parameters, such as based upon a center point and radius, a particular corner location along with the width and height, and/or a list of points along the perimeter. In other embodiments, however, the apparatus 20, such as the processing circuitry 22, of an example embodiment, is configured to determine the perimeter of the grid within which the corrections are sought to have an irregular shape. By having an irregular shape, the perimeter of the grid is not symmetrical about a center point, such as about the estimated current location of the navigation device, but is, instead, asymmetrical. In this regard, the perimeter of a grid having an irregular shape may have a polygonal shape, but the sides of the polygon are not all the same length and the interior angles of the polygon are not all the same. By way of example, in an instance in which the navigation device is in motion, the perimeter of the grid may be determined to extend further in the direction in which the navigation device is moving, than in the opposite direction away from which the navigation device is moving.

The request may optionally include further information in addition to the identification of the one or more correction points of the grid within which the corrections are sought. For example, the apparatus 20 of an example embodiment includes means, such as the processing circuitry 22 or the like, for configuring the request to also identify an update rate at which information associated with the corrections is to be updated by the service provider 14 and provided to the requesting device, such as the navigation device 10. As such, the apparatus of this example embodiment is configured to tailor not only the definition of the grid including the perimeter of the grid within which corrections are sought and the correction points that populate the grid, but also the rate at which the information associated with the corrections will be provided in the future. Additionally or alternatively, the request may also be configured to identify the navigation satellites 12, such as the GNSS constellation, for which information associated with corrections is requested.

As shown in block 34 of FIG. 3, the apparatus 20 of this example embodiment also includes means, such as the processing circuitry 22, the communication interface 26 or the like, for receiving, in response to the request, information associated with the corrections. Various types of information associated with the corrections may be provided. In an example embodiment, the information associated with the corrections is in the form of TEC values for each of the one or more correction points of the grid. In this example embodiment, both STEC values and VTEC values may be provided at each of the correction points. While the information associated with the corrections may be provided in the form of TEC values, the information associated with the correction points may be provided in a variety of other manners in other example embodiments with the information associated with the corrections intending in each instance to compensate for at least some of the atmospheric delay and/or advance of the navigation signals propagating through the atmosphere, such as the ionosphere, that are utilized to determine a position, such as the position of the navigation device 10, in accordance with a satellite-based positioning technique, such as a GNSS-based positioning technique.

The apparatus 20 of this example embodiment also includes means, such as the processing circuitry 22 or the like, for determining a position within the perimeter of the grid for which corrections are sought with the position determined based upon a satellite-based positioning technique in combination with the received information associated with the corrections. See block 36 of FIG. 3. Although the position may be determined in various manners, the apparatus, such as the processing circuitry, of an example embodiment is configured to determine the position, such as the position of the navigation device 10, utilizing a satellite-based positioning technique, such as a GNSS-based positioning technique, as well as the information received that is associated with the corrections at each of the one or more correction points, such as the information associated with corrections attributable to an atmospheric model, such as an atmospheric model as defined by the LPP specification, the QZSS atmosphere model or the SPARTN atmosphere model. As such, the apparatus, such as the processing circuitry, of this example embodiment is configured to update the position, such as the position of the navigation device, in such a manner that at least some of the atmospheric delay and/or advance of the navigation signals transmitted from a navigation satellite 12 to a receiver, such as the receiver of the navigation device, are corrected so as to take into account the atmosphere delay and/or advance experienced by the navigation signals while propagating through the atmosphere, such as the ionosphere. Thus, the resulting updated position, such as the position of the navigation device, that is determined is a more accurate representation of the position as at least some of the atmospheric delay and/or advance of the navigation signals propagating through the atmosphere, such as the ionosphere, and utilized by a satellite-based positioning technique has been corrected.

As such, the method, apparatus 20 and computer program product of this example embodiment is configured to determine a position within a perimeter of the grid, such as the position of a navigation device 10 or a position within a region serviced by a data provider, a telecommunications provider or the like, in an accurate manner by correcting for at least some of the atmospheric delay and/or advance of the signals propagating through the atmosphere, such as the ionosphere, and utilized by a satellite-based positioning technique to determine the position. In doing so, the method, apparatus and computer program product of this example embodiment tailor the information associated with the corrections that is requested, received and then utilized in conjunction with the determination of the position, such as the position of the navigation device, such that the information regarding the corrections that is most useful is obtained. For example, the information regarding the corrections may be useful for the navigation device by being associated with the grid within which the navigation device is located, by being of a desired resolution and/or by being updated at a desired rate. Thus, the position of the navigation device may be accurately updated in an efficient manner by ensuring that the information regarding the corrections that is most useful is obtained. Moreover, by permitting the request to be tailored by the requesting device, a requesting device is not limited to a predefined grid layout and the information associated with the corrections that is requested may be tailored to satisfy the requirements of the requesting device. Although described above in conjunction with information regarding the corrections for navigation signals transmitted by a single navigation satellite 12, this process may be performed for the navigation signals transmitted by each of a plurality of navigation satellites to the navigation device.

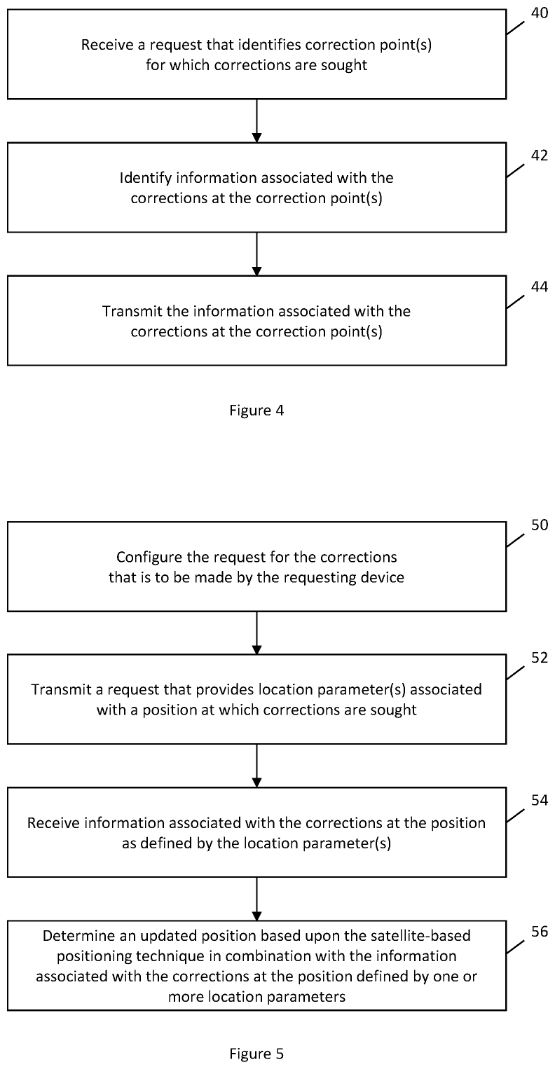

Referring now to FIG. 4, the operations performed, such as by the apparatus 20 of FIG. 2 as embodied by a computing device of a service provider 14, are depicted. The apparatus of this example embodiment is configured to respond to a customized request for correction from a requesting device, such as a navigation device 10 that utilizes a satellite-based positioning technique, such as a customized request for corrections as described above in conjunction with FIG. 3. The corrections are utilized for compensating for at least some of the atmospheric delay and/or advance of the navigation signals transmitted from a navigation satellite 12 to a receiver, such as the receiver of the navigation device, and utilized in conjunction with a satellite-based positioning technique, such as a GNSS-based positioning technique, to determine the requested position, such as the position of the navigation device.

As shown in block 40 of FIG. 4, the apparatus 20 includes means, such as the processing circuitry 22, the communication interface 26 or the like, for receiving a request that identifies one or more correction points for which corrections are sought. The request that is received and the one or more correction points identified by the request may be defined and configured as described above in conjunction with FIG. 3. For example, the request that is received may identify the density of the correction points of a grid for which information associated with the corrections is sought. By way of example, the apparatus, such as the processing circuitry, the communication interface, or the like, may be configured to receive a request that defines an array of the one or more correction points based upon a reference point, a number of correction points or steps in each of one or more directions and a step size between adjacent correction points. Alternatively, the apparatus, such as the processing circuitry, the communication interface or the like, of another example embodiment is configured to receive a request that defines a list of the one or more correction points. The list may individually identify the correction points or may be based upon a reference point and a difference between adjacent correction points. As also described above, the request as received may include information in addition to the identification of the one or more correction points. For example, the apparatus, such as the processing, the communication interface or the like, may be configured to receive a request that also identifies the update rate at which information associated with the corrections at the one or more correction points is to be updated by the service provider 14.

As shown in block 42 and in response to the request, the apparatus 20 also includes means, such as the processing circuitry 22 or the like, for identifying information associated with the corrections at the one or more correction points of a grid. The information associated with the corrections for at least some of the atmospheric delay and/or advance experienced by navigation signals propagating through the atmosphere, such as the ionosphere, may be identified in various manners and may have various forms. For example, in an embodiment in which the request defines an array of the one or more correction points, the apparatus, such as the processing circuitry, may be configured to identify the information associated with the corrections at the array of the one or more correction points. Similarly, in an embodiment in which the request defines a list of the one or more correction points, the apparatus, such as the processing circuitry. may be configured to identify the information associated with the corrections at the list of the one or more correction points.

Regardless of the manner in which the correction points are identified, the information associated with the corrections may have any of a variety of different forms. For example, the information associated with the corrections may be in the form of TEC values for each of the one or more correction points of the grid. In this example embodiment, both STEC values and VTEC values may be identified at each of the correction points. While the information associated with the corrections that is identified may be in the form of TEC values, the information associated with the correction points that is identified may be in any of a variety of other formats in other example embodiments with the information associated with the corrections intending in each instance to compensate for at least some of the atmospheric delay and/or advance of the navigation signals propagating through the atmosphere, such as the ionosphere.

As shown in block 44, the apparatus 20 also includes means, such as the processing circuitry 22, the communication interface 26, or the like, for transmitting, such as toward the requesting device, e.g., the navigation device 10, the information associated with the corrections at the one or more correction points. The information associated with the corrections that is transmitted may be any of a variety of information, such as the information identified in the manner described above including, for example, TEC values at the one or more correction points. In an embodiment in which the request identifies an update rate, the apparatus, such as the processing circuitry, the communication interface or the like, is configured to repeatedly identify the information associated with the corrections in accordance with the update rate and to correspondingly, repeatedly transmit the information associated with the corrections in accordance with the update rate. For example, the method, apparatus and computer program product of this example embodiment are configured to respond to a customized request for corrections from a navigation device that utilizes a satellite-based positioning technique to determine the position of the navigation device with the corrections compensating for at least some of the atmospheric delay and/or advance experienced by navigation signals propagating through the atmosphere, such as the ionosphere. As described above, the information associated with the corrections that is identified and transmitted may be tailored to the requesting device, such as the navigation device, based upon the request received therefrom such that the information regarding the corrections that is most useful to the requesting device is identified and transmitted in an efficient manner.

Referring now to FIG. 5, the operations performed, such as by the apparatus 20 of FIG. 2 as embodied by or associated with a requesting device, such as a navigation device 10, are depicted in order to enable a request for corrections to be made by the requesting device. In an example embodiment, the request for corrections may be based at least in part upon the position of the navigation device, such as the estimated current position of the navigation device. As described above, the corrections that are requested compensate for at least some atmospheric delay and/or advance experienced by navigation signals while propagating through the atmosphere, such as the ionosphere, and utilized in conjunction with a satellite-based positioning technique, such as a GNSS-based positioning technique, to determine a position, such as an updated position of the navigation device.

As shown in block 50 of FIG. 5, the apparatus 20 includes means, such as the processing circuitry 22 or the like, for configuring the request for the corrections that is to be made by the requesting device, such as the navigation device 10. The request may be configured in various manners, but, in one embodiment, the request provides information regarding the position for which corrections are sought, such as information regarding the estimated current position of the navigation device. The position for which corrections are sought may be defined in various manners including, for example, by one or more location parameters associated with the position at which the corrections are sought, such as the estimated current position of the navigation device. Various location parameters may be provided including, for example, the latitude and longitude of the estimated current position of the navigation device. As described above in conjunction with FIG. 3, the position of the navigation device that is determined at the time at which the request for corrections is made may be defined in various manners.

The apparatus 20, such as the processing circuitry 22, may configure the request for corrections to include further information in addition to information regarding the position for which corrections are sought. For example, the request may be configured to include one or more points within a perimeter of the grid for which corrections are to be made. The points may be defined in various manners, including as an array or as a list of points as described above. Regardless of the manner in which the points are identified, the points generally extend throughout and cover the grid for which corrections are sought. Additionally or alternatively, the apparatus, such as the processing circuitry, may be configured to configure the request to include an update rate at which the information associated with the corrections at the one or more points is to be updated by the service provider 14.

The apparatus 20, such as the processing circuitry 22, of an example embodiment may be configured to configure the request to identify the size of the grid and, in turn, area within the perimeter of the grid for which the information associated with the corrections is sought. Alternatively, the grid for which the information associated with the corrections is sought may be of a predefined size with the grid positioned relative to the position for which location parameters are provided, such as by being centered about the position for which location parameters are provided. In this alternative embodiment, the request need not include the size of the grid. In some example embodiments, the apparatus, such as the processing circuitry, is also configured to identify the shape of the grid, such as by identifying the perimeter of the grid, for which information associated with the corrections is sought.

Following configuration of the request, the apparatus 20 includes means, such as the processing circuitry 22, the communication interface 26 or the like, for transmitting, toward a service provider 14, the request that provides one or more location parameters associated with a position at which the corrections are sought, such as the estimated current position of the navigation device 10. See block 52 of FIG. 5. While the request that is transmitted may simply identify the one or more location parameters associated with the position at which corrections are sought, the request may also include additional information, such as the update rate, the size and/or shape of the grid, as defined by the perimeter of the grid, for which information regarding corrections is requested. For example, in an embodiment in which the request identifies an array of points, the location parameters associated with the position at which corrections are sought may serve as a reference point with the request also identifying the number of points or steps in each of one or more directions from the reference point and the step size between adjacent points. Alternatively, in an instance in which the request identifies a list of one or more points, the location parameters associated with the position at which corrections are sought may serve as the reference point with the request also identifying the difference between adjacent points for which information regarding the corrections is to be provided.

As shown in block 54, the apparatus 20 also includes means, such as the processing circuitry 22, the communication interface 26 or the like, for receiving information associated with the corrections at the position as defined by the one or more location parameters, e.g., the estimated current position of the navigation device 10. As described above, the information associated with the corrections may be provided in a variety of different manners including, for example, as TEC values, e.g., VTEC values and STEC values, at each of a plurality of correction points. In an example embodiment, the apparatus, such as the processing circuitry, the communication interface or the like, is configured to receive the information associated with the corrections at correction points of a grid that may, in some embodiments, be located as to include at least the position for which location parameters were provided, such as the position of the navigation device. In another example embodiment, the apparatus, such as the processing circuitry, the communication interface or the like, is configured to receive the information associated the corrections for a plurality of girds identified based upon the position for which location parameters were provided, such as the position of the navigation device. For example, the plurality of grids may include the position of the navigation device as well as grids proximate to and at least partially surrounding the position of the navigation device. As noted above by way of example but not of limitation, the grid(s) may be compatible with the LPP specification, the QZSS atmosphere model and/or the SPARTN atmosphere model, but may be tailored based upon the position of the navigation device.

As shown in block 56, the apparatus 20 also includes means, such as processing circuitry 22 or the like, for determining an updated position, such as an updated position of the navigation device 10, based upon the satellite-based positioning technique in combination with the information associated with the corrections at the position defined by the one or more location parameters, e.g. at the estimated current position of the navigation device. Although, the updated position may be determined in various manners, the apparatus, such as the processing circuitry, of an example embodiment utilizes a satellite-based positioning technique, such as a GNSS-based positioning technique, and is configured to determine the updated position of the navigation device by compensating for at least some of the atmospheric delay and/or advice of the navigation signals transmitted by a navigation satellite 12 to a receiver, such as a receiver of the navigation device, such as by updating the position in reliance upon an atmospheric model, such as an atmospheric model as defined by the LPP specification, the QZSS atmosphere model or the SPARTN atmosphere model, thereby reducing or eliminating the positional inaccuracy otherwise attributable to the atmospheric delay and/or advance of the navigation signals while propagating through the atmosphere, such as the ionosphere. Thus, the resulting updated position may be more accurate than that initially determined.

In an example embodiment in which the request includes an update rate, the apparatus 20, such as the processing circuitry 22, the communication interface 26 or like, is configured to repeatedly receive information associated with the corrections at the position at which corrections are sought, e.g., the estimated current position of the navigation device 10, in accordance with the update rate. And, the apparatus, such as the processing circuitry or the like, of this example embodiment is configured to repeatedly determine the updated position based at least in part upon the information associated with the corrections at the position as defined by the one or more location parameters, e.g., the estimated current position of the navigation device, as updated in accordance with the update rate. As such, the updated position that is determined may not only be more accurate by compensating for the delay and/or advance of the signals propagating through the atmosphere, such as the ionosphere, but may also be updated in a regular manner so as to maintain its enhanced accuracy.

The apparatus 20, method and computer program product of this example embodiment therefore permit a request for corrections to be made by a requesting device with the request being tailored based upon the position for which corrections are sought. As such, the information regarding corrections that is received by the requesting device is relevant to the requesting device and permits the position to updated without requesting information regarding corrections for other more remote regions that would not facilitate updating of the but, instead, that would unnecessarily consume processing and communication resources. Thus, the information regarding the corrections that is requested is both useful to updating the position and is provided in an efficient manner. Moreover, by basing the information associated with the corrections that is identified and transmitted based upon a request that identifies the position for which corrections are sought, such as the position of the navigation device, the requesting device need not identify one or more particular grids for which correction information is requested and also need not attempt to determine the most optimal grid for which correction information is to be requested. Although described above in conjunction with information regarding the corrections for navigation signals transmitted by a single navigation satellite 12, this process may be performed for the navigation signals transmitted by each of a plurality of navigation satellites.

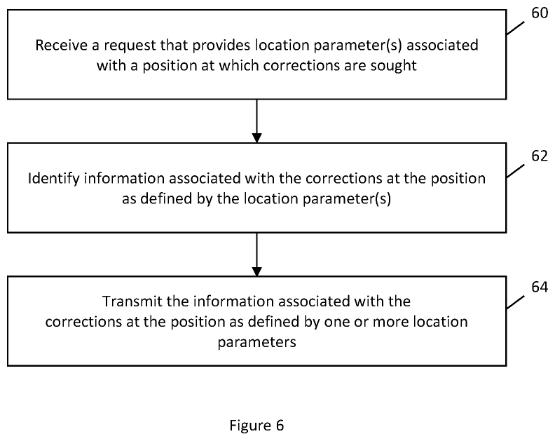

Referring now to FIG. 6, the operations performed, such as by the apparatus 20 of FIG. 2 as embodied by or associated with the computing device, e.g., server, of the service provider 14, are depicted. As described below, the apparatus 20 of this example embodiment is configured to respond to request for corrections from a requesting device. The corrections address at least some of the atmospheric delay and/or advance experienced by navigation signals transmitted by a navigation satellite 12 and received by a receiver, such as a receiver of the navigation device. The navigation signals are, in turn, utilized in accordance with a satellite-based positioning technique, such as a GNSS-based positioning technique, to determine a position, such as the position of the navigation device. As described above in conjunction with FIG. 6, the request for corrections to which the apparatus of this example embodiment is configured to respond is based at least in part upon location parameters associated with a position, e.g., an estimated current position of the navigation device, such that the information regarding the corrections that is provided is relevant for the position of the requesting device, such as the navigation device.

As shown in block 60, the apparatus 20 of this example embodiment includes means, such as the processing circuitry 22, the communication interface 26 or the like, for receiving a request that provides one or more location parameters associated with the position at which corrections are sought, e.g., the estimated current location of the navigation device 10. As described above, various location parameters may be provided including, for example, the latitude and longitude of the position for which corrections are sought, such as the estimated current position of the navigation device. The request may optionally include further information in addition to information regarding the position for which corrections are sought. For example, the request that is received may identify the density of the correction points of a grid for which information associated with the corrections is sought. In this regard, the request may include one or more correction points of a grid for which corrections are to be made, such as an array or as a list of correction points as described above. The request may include an update rate at which the information associated with the corrections at the one or more correction points is to be updated by the service provider 14. Additionally or alternatively, the request of an example embodiment identifies the size and/or shape of the grid, such as by identifying the perimeter of the grid, including at least the position for which the information associated with the corrections is sought, such as the position of the navigation device.

In response to the request and as depicted in block 62, the apparatus 20 includes means, such as the processing circuitry 22 or the like, for identifying information associated with the corrections at the position as defined by the one or more location parameters, e.g., the estimated current location of the navigation device 10. The information as identified may be any of a variety of types of information associated with the corrections including, for example, TEC values, e.g., VTEC values and STEC values, at each of a plurality of correction points.

The apparatus 20, such as the processing circuitry 22, may be configured to identify the information associated with the corrections in various manners. In one example embodiment, the apparatus, such as the processing circuitry, is configured to identify the information associated with corrections at correction points of a grid that includes the position for which information regarding the corrections is sought, such as the position of the navigation device 10. In another example embodiment, the apparatus, such as the processing circuitry, is configured to identify the information associated with the corrections for a plurality of grids identified based upon the position for which information regarding the corrections is sought, such as the position of the navigation device. For example, the plurality of grids may include the position of the navigation device as well as grids proximate to and at least partially surrounding the position of the navigation device.

As shown in block 64, the apparatus 10 also includes means, such as the processing circuitry 22, the communication interface 26 or the like, for transmitting, towards the requesting device, e.g., the navigation device 10, the information associated with the corrections at the position for which information regarding the corrections is sought, e.g. at the estimated current position of the navigation device. Based upon the information associated with the corrections at the position of interest, the navigation device may then be configured to determine an updated position, such as an updated position of the navigation device. In this regard, the position may be updated so as to be more accurate, such as by compensating for the delays and/or advances of the navigation signals propagating through the atmosphere, such as the ionosphere. Additionally, by identifying and then transmitting the information associated with the corrections based upon the position as defined by the one or more location parameters, the information associated with the corrections that will be relevant for purposes of updating the position, such as for updating the position of the navigation device, is provided without necessarily identifying and transmitting information associated with corrections for more remote regions, thereby also increasing the efficiency with which the information regarding the corrections is identified and transmitted.

As noted above, the request that is received may provide additional information in addition to one or more location parameters associated with the position for which information associated with the corrections is sought. For example, the request may also identify an update rate at which the information associated with the corrections at the position is to be updated. In this example embodiment, the apparatus 20, such as the processing circuitry 22, is configured to repeatedly identify the information associated with the corrections in accordance with the update rate and to repeatedly transmit the information associated with the corrections in accordance with the update rate.

In another example embodiment, the request that is received identifies the perimeter of the grid and, as a result, the shape of the grid, including the position, such as the position of the navigation device 10, for which information associated with the corrections is sought. In this example embodiment, the apparatus 20, such as the processing circuitry 22, is configured to receive the request that identifies the perimeter of the grid and to then identify and transmit information associated with the corrections at correction points of a grid having the shape defined by the perimeter identified by the request. By identifying the perimeter of the grid, the request that is received also identifies the size of the grid, including the position for which information associated with the corrections is sought. In this example embodiment, the apparatus, such as the processing circuitry, is configured to receive the request identifying the perimeter of the grid and to then identify and transmit information associated with the corrections at correction points of a grid having the size defined by the perimeter identified by the request.

As described above, FIGS. 3-6 are flow diagrams of an apparatus 20, method, and computer program product configured to allow requests for information associated with atmospheric corrections to be tailored, such as based upon the requirements and/or the position of the navigation device 10 according to an example embodiment. It will be understood that each block of the flow diagrams, and combinations of blocks in the flow diagrams, may be implemented by various means, such as hardware, firmware, processing circuitry 22, and/or other devices associated with execution of software including one or more computer program instructions. For example, one or more of the procedures described above may be embodied by computer program instructions. In this regard, the computer program instructions which embody the procedures described above may be stored by the memory device 24 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the blocks of the flow diagrams. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the blocks of the flow diagrams.

Accordingly, blocks of the flow diagrams support combinations of means for performing the specified functions and combinations of operations for performing the specified functions. It will also be understood that one or more blocks of the flow diagrams, and combinations of blocks in the flow diagrams, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for enabling a customized request for corrections to be made by a requesting device, the corrections being for at least some atmospheric delay and/or advance incurred in conjunction with a satellite-based positioning technique, the method comprising:
determining a perimeter of a grid within which the corrections are sought;
transmitting, toward a service provider, a request that identifies one or more correction points within the perimeter of the grid;
in response to the request, receiving information associated with the corrections; and
determining a position based upon the satellite-based positioning technique in combination with the received information associated with the corrections.

2. A method according to claim 1, further comprising defining an array of the one or more correction points based upon a reference point, a number of correction points or steps in each of one or more directions and a step size between adjacent correction points so as to populate the grid for which the information associated with the corrections is sought.

3. A method according to claim 1, further comprising defining a list of the one or more correction points, wherein the list of the one or more correction points: (i) defines individual correction point(s) or (ii) is based upon a reference point and a difference between adjacent correction points, and wherein the list is defined so as to populate the grid for which the information associated with the corrections is sought.

4. A method according to claim 1, further comprising defining the one or more correction points such that the one or more correction points for which the information is received have a predefined density.

5. A method according to claim 1, further comprising configuring the request to also identify an update rate at which the information associated with the corrections is to be updated by the service provider.

6. An apparatus configured to respond to a customized request for corrections from a requesting device, the corrections being for at least some atmospheric delay and/or advance incurred in conjunction with a satellite-based positioning technique, the apparatus comprising processing circuitry and at least one memory including computer program code, the at least one memory and the computer program code configured to, with the processing circuitry, cause the apparatus at least to:
receive a request that identifies one or more correction points for which corrections are sought;
in response to the request, identify information associated with the corrections at the one or more correction points; and
transmit, toward the requesting device, the information associated with the corrections at the one or more correction points.

7. An apparatus according to claim 6, wherein the at least one memory and the computer program code are configured to, with the processing circuitry, cause the apparatus to receive the request by receiving the request that defines an array of the one or more correction points based upon a reference point, a number of correction points or steps in each of one or more directions and a step size between adjacent correction points, and wherein the at least one memory and the computer program code are configured to, with the processing circuitry, cause the apparatus to identify the information by identifying the information associated with the corrections at the array of the one or more correction points.

8. An apparatus according to claim 6, wherein the at least one memory and the computer program code are configured to, with the processing circuitry, cause the apparatus to receive the request by receiving the request that defines a list of the one or more correction points, wherein the list of the one or more correction points: (i) defines individual correction point(s) or (ii) is based upon a reference point and a difference between adjacent correction points, and wherein the at least one memory and the computer program code are configured to, with the processing circuitry, cause the apparatus to identify the information by identifying the information associated with the corrections at the list of the one or more correction points.

9. An apparatus according to claim 6, wherein the at least one memory and the computer program code are configured to, with the processing circuitry, cause the apparatus to receive the request by receiving the request that also identifies an update rate at which the information associated with the corrections at the one or more correction points is to be updated, and wherein the at least one memory and the computer program code are configured to, with the processing circuitry, cause the apparatus to repeatedly identify the information associated with the corrections and to repeatedly transmit the information associated with the corrections in accordance with the update rate.

10. A method for enabling a request for corrections to be made by a requesting device, the corrections being for at least some atmospheric delay and/or advance incurred in conjunction with a satellite based positioning technique, the method comprising:
transmitting, toward a service provider, the request that provides one or more location parameters associated with a position at which the corrections are sought;
receiving information associated with the corrections at the position as defined by the one or more location parameters; and
determining an updated position based upon the satellite-based positioning technique in combination with the information associated with the corrections at the position defined by the one or more location parameters.

11. A method according to claim 10, wherein receiving information comprises receiving the information associated with the corrections at correction points of a grid.

12. A method according to claim 10, wherein receiving information comprises receiving the information associated with the corrections at correction points of a plurality of grids identified based upon the position as defined by the one or more location parameters.

13. A method according to claim 10, further comprising configuring the request to identify an update rate at which the information associated with the corrections at the position, as defined by the one or more location parameters, is to be updated by the service provider.

14. A method according to claim 10, further comprising configuring the request to identify a perimeter of a grid including at least the position, as defined by the one or more location parameters, within which the information associated with the corrections is sought.

15. A method according to claim 10, further comprising configuring the request to identify a density of correction points of a grid including at least the position, as defined by the one or more location parameters, for which the information associated with the corrections is sought.

16. An apparatus configured to respond to a request for corrections for at least some atmospheric delay and/or advance incurred in conjunction with a satellite-based positioning technique, the apparatus comprising processing circuitry and at least one memory including computer program code, the at least one memory and the computer program code configured to, with the processing circuitry, cause the apparatus at least to:
receive a request that provides one or more location parameters associated with a position at which the corrections are sought;
in response to the request, identify information associated with the corrections at the position as defined by the one or more location parameters; and
transmit the information associated with the corrections at the position as defined by one or more location parameters.

17. An apparatus according to claim 16, wherein the at least one memory and the computer program code are configured to, with the processing circuitry, cause the apparatus to identify the information associated with the corrections by identifying the information associated with the corrections at correction points of a grid.

18. An apparatus according to claim 16, wherein the at least one memory and the computer program code are configured to, with the processing circuitry, cause the apparatus to identify the information associated with the corrections by identifying the information associated with the corrections at correction points of a plurality of grids identified based upon the position as defined by the one or more location parameters.

19. An apparatus according to claim 16, wherein the at least one memory and the computer program code are configured to, with the processing circuitry, cause the apparatus to receive the request by receiving the request that also identifies an update rate at which the information associated with the corrections at the position, as defined by the one or more location parameters, is to be updated, and wherein the at least one memory and the computer program code are configured to, with the processing circuitry, cause the apparatus to repeatedly identify the information associated with the corrections and repeatedly transmit the information associated with the corrections in accordance with the update rate.

20. An apparatus according to claim 16, wherein the at least one memory and the computer program code are configured to, with the processing circuitry, cause the apparatus to receive the request by receiving the request that also identifies a perimeter of a grid including at least the position, as defined by the one or more location parameters, within which the information associated with the corrections is sought.

21. An apparatus according to claim 16, wherein the at least one memory and the computer program code are configured to, with the processing circuitry, cause the apparatus to receive the request that also identifies a density of correction points of a grid including at least the position, as defined by the one or more location parameters, for which the information associated with the corrections is sought.
